(19) United States
(12) Patent Application Publication
(10) Pub. No.: US 2010/0141749 A1
(43) Pub. Date: Jun. 10, 2010

(54) METHOD AND APPARATUS FOR INFORMATION PROCESSING

(75) Inventor: Masatoshi MURAKAMI, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/578,966

(22) Filed: Oct. 14, 2009

(30) Foreign Application Priority Data
Dec. 5, 2008 (JP) 2008-311465

(51) Int. Cl. G05B 19/00; H04N 7/18

(52) U.S. Cl. 348/77; 340/5.83; 382/118; 348/161; 348/E07.085

(57) ABSTRACT

According to one of embodiments, a system of facial information processing being captured facial image data of a user, and a feature point of a face of the user is extracted from this facial image data and encoded. The facial image data is associated with a unique identifier and/or the encoded feature point to be registered in an address management table.

### CROSS-REFERENCE TO RELATED APPLICATIONS

This application is based upon and claims the benefit of priority from Japanese Patent Application No. 2008-311465, filed Dec. 5, 2008, the entire contents of which are incorporated herein by reference.

### BACKGROUND

1. Field

The present invention relates to an information processing method and an information display apparatus utilizing face authentication. More specifically, the present invention relates to an information processing method that enables electronically exchanging (transmitting/receiving) video mail contents through a content collection device (e.g., a video recorder) or a content display device (e.g., a digital TV) without using a keyboard by recognizing a face of a user acquired by a camera, and to an information (message) display apparatus utilized in this method.

2. Description of the Related Art

Electronic mails have convenience that is not observed in phones (e.g., the other party does not have to be present in that location at that time, or a recipient side can see contents any time and anywhere). Therefore, mails have widely spread but have the following difficulties as compared with phones.

1> Using a keyboard to input information is general, but this is a large obstacle for elderly persons, young children, or disabled persons who are bad at using a keyboard.

2> Since a keyboard is required, there is a limit in an environment for transmitting or receiving mails (e.g., an environment where a mobile phone or a personal computer (PC) can be utilized is required).

3> It takes time to transmit a mail since a document text of the mail must be created, or a mail cannot be rapidly transmitted even though a user wants to inform the other party with something (the phone is easy since just making a call to talk can suffice, but the mail does not have such convenience).

4> The electronic mail is not oriented to a use application that a plurality of persons, e.g., family members see a mail and the respective persons offer responses.

It should be noted that a TV telephone dedicated device or a personal computer conventionally has a TV telephone function or a video chat function, but such a function is a continuation of the phone and does not have the above-explained convenience of the mail (e.g., the other person does not have to be present in that location at that time).

As a method of obtaining a mail environment where the difficulties of the mail are decreased as much as possible, a method utilizing face authentication can be considered. As a prior art utilizing a face authentication function, there is “Electronic Mail Creation Method and Apparatus Utilizing Image Recognition Function” disclosed in Japanese Patent Application Publication (KOKAI) No. 2005-267146.

In the Japanese Patent Application Publication, in a <mail address automatic acquisition process>, a facial image retrieval unit 104 (FIG. 1) uses feature point data received from an image analysis unit 103 as a key to retrieve facial image data registered in an address book memory 105, and outputs a mail address associated with this facial image to a mail creation unit 106 if a corresponding facial image is present. When the feature point data received from the image analysis unit 103 includes a plurality of faces, all faces are searched, and a mail address associated with a corresponding facial image is output (a paragraph [0017]). In the address book memory 105, an address book 105.1 storing names, mail addresses, and facial image data of a plurality of persons to enable retrieval is provided, and a mailing list 105.2 including mail addresses of respective persons in a group photo image can be also registered (a paragraph [0018]).

According to the Japanese Patent Application Publication, in a <facial image retrieval process>, image analysis data received from an image analysis unit 205 (FIG. 2) is used as a key to retrieve facial image data registered in an address book memory 207. Further, if a facial image that coincides with the image analysis data is present in the address book memory 207, a mail address associated with this facial image is read out [a paragraph 0031].

That is, a face of a person who appears in a photograph taken by a camera of a portable communication terminal is recognized by using the technique disclosed in the above-described document, a “table in which faces and mail addresses of persons are registered in advance” is searched by using the recognized face to find out a mail address of the person who appears in the photograph, and the photograph is transmitted to this person. With such an operation, if contents transmitted through a mail can be created without a keyboard like a photograph, even a user who is unaccustomed to using a keyboard can readily transmit a mail.

However, when “using the face authentication function” disclosed in the document is adopted, there arises a problem that a mail may be possibly transmitted to a wrong person, for example. That is, face recognition that is 100% assured in processing using a machine alone is technologically difficult at present.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an entire mail system utilizing face authentication according to an embodiment of the invention is applied;

FIG. 2 is an exemplary diagram showing an example of an address management table utilized by the system depicted in FIG. 1 according to an embodiment of the invention;

FIG. 3 is an exemplary diagram showing an example of a flow of a user operation in the system depicted in FIG. 1 according to an embodiment of the invention;

FIG. 4 is an exemplary diagram showing an example of “arrival notification processing” in the system depicted in FIG. 1 according to an embodiment of the invention;

FIG. 5 is an exemplary diagram showing an example of “mail folder choice display processing” in the system depicted in FIG. 1 according to an embodiment of the invention;

FIG. 6 is an exemplary diagram showing an example of “received mail list display processing” in the system depicted in FIG. 1 according to an embodiment of the invention;

FIG. 7 is an exemplary diagram showing an example of “mail transmission processing” in the system depicted in FIG. 1 according to an embodiment of the invention;

FIG. 8 an exemplary diagram showing an example of “mail registration processing” in the system according to an embodiment of the invention; and

FIG. 9 is an exemplary diagram showing an example of a structure of a face authentication/collation processing apparatus which can be applied to the system depicted in FIG. 1 according to an embodiment of the invention.

### DETAILED DESCRIPTION

Various embodiments according to the invention will be described hereinafter with reference to the accompanying drawings. In general, according to one embodiment of the invention, an information processing method comprising: capturing facial image data of a user; extracting a feature point of a face of the user from the facial image data and encoding the feature point; and associating the facial image data with a unique identifier and/or the encoded feature point to be registered in an address management table.

Embodiments of this invention will now be described hereinafter in detail with reference to the accompanying drawings.

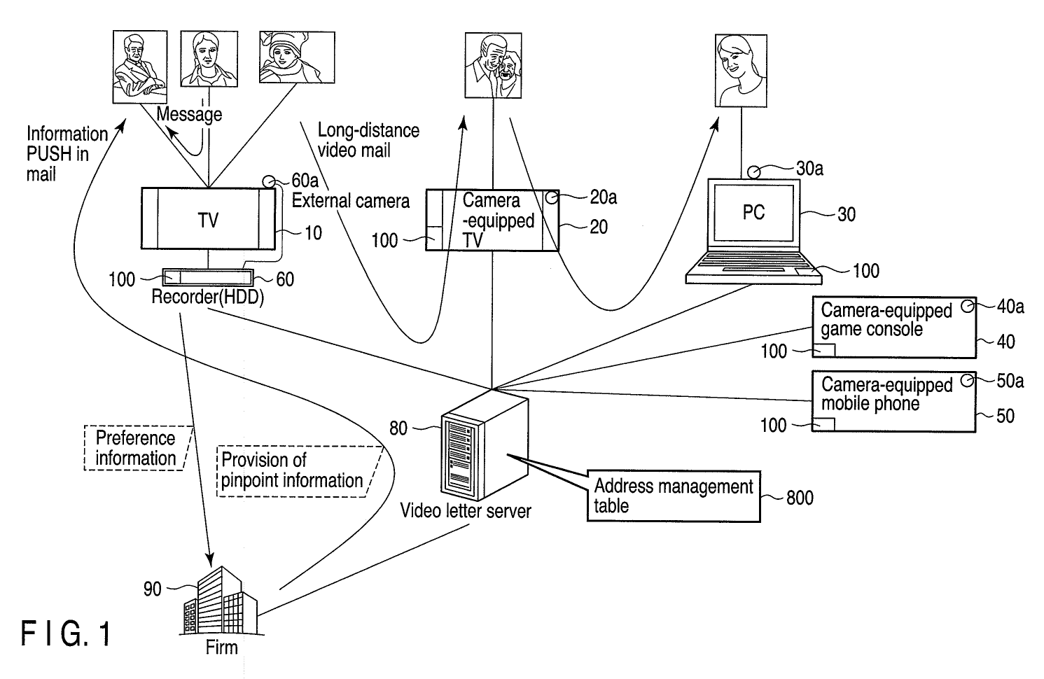

FIG. 1 shows an entire mail system utilizing face authentication to which the present invention is applied. The systems described herein can be implemented as software applications, hardware and/or software modules, or components on one or more computers, such as servers. While the various modules are illustrated separately, they may share some or all of the same underlying logic or code.

The mail system depicted in FIG. 1 can be constituted of at least one of a television receiver (a domestic user terminal) 10 that receives and reproduces a television broadcast signal provided from a broadcasting company or a relay enterprise based on a wireless scheme using space waves or a line transmission scheme utilizing, e.g., an optical fiber, a video recorder apparatus (a domestic user terminal) 60 that holds a high-capacity storage typified by a hard disk drive (HDD), and an information reproducing apparatus (a domestic user terminal) 30 which is called, e.g., a photo frame, and a video letter server 80 which is connected with the domestic user terminals through a network, e.g., an optical fiber network or a public communication network. It should be noted that imagery/audio of a user who is in front of a camera as well as existing contents can be added to a video mail. As the existing contents (which must not entrench on rights such as a copyright of other persons), there are a video picture taken by a user before, a digital camera image taken by the user before, audio/music recorded by the user before, video/audio (music) of a broadcast program already recorded in a video recorder, Internet-delivery video/audio (music) belonging to a public domain, and others.

Besides, to the server 80 are appropriately connected a digital TV 20 having a camera 20a, an external personal computer (a PC) 30 having a camera 30a, a computer game console 40 having a camera 40a, a mobile phone 50 having a camera 50a, and others through the Internet.

A terminal of a contract firm 90 is connected with a provider who manages the server 80. Based on this provider, preference information of each terminal user can be collected through the Internet, and pinpoint information satisfying the preference of each terminal user can be provided to this user. For example, in the system depicted in FIG. 1, preferences of each user can be learned (e.g., categories of programs having high viewing frequencies are totalized) from, e.g., broadcasting programs in the TV 10 that a user whose face has been recognized by a camera 60a of the recorder 60 watches or reproduced contents in the recorder 60, and a result of learning can be transmitted to the server 80. Then, the firm 90 can transmit an advertising mail meeting user preferences to a targeted user. At this time, placing a video advertisement in a mail list enables attracting the user's attention.

A face authentication/collation processing apparatus 100 is incorporated in each user terminal (20 to 60) so that features of a face of a user who is in front of the camera 60a can be encoded or features of a face of a user who is in front of the camera can be collated with features of registered faces in each user terminal. Image data of faces of users taken in by the cameras of the user terminals, feature point data obtained by encoding features of faces by the face authentication/collation processing apparatus 10, and others are registered in an address management table 800 provided in the server 80. A video mail itself (mail contents) from each user is associated with registered contents in the address management table 800 to be stored in a non-illustrated data storage in the server 80. Details of the address management table 800 and those of the face authentication/collation processing apparatus 100 will be described later.

In the system depicted in FIG. 1, a facial image that can be visually recognized by a user him/herself can be determined as an address to transmit/receive an in-family message mail through a domestic local area network of the user, or a video mail can be transmitted to another user who is at a remote place through the Internet.

At home, contents of the management information table 800 can be copied in a built-in HDD (not shown) of, e.g., the TV 10 or the recorder 60. Then, an in-family video mail (or message) can be exchanged by using a single device, e.g., the TV 10 or the recorder 60. In this case, the TV 10 or the recorder 60 has functions of the server 80 on the Internet.

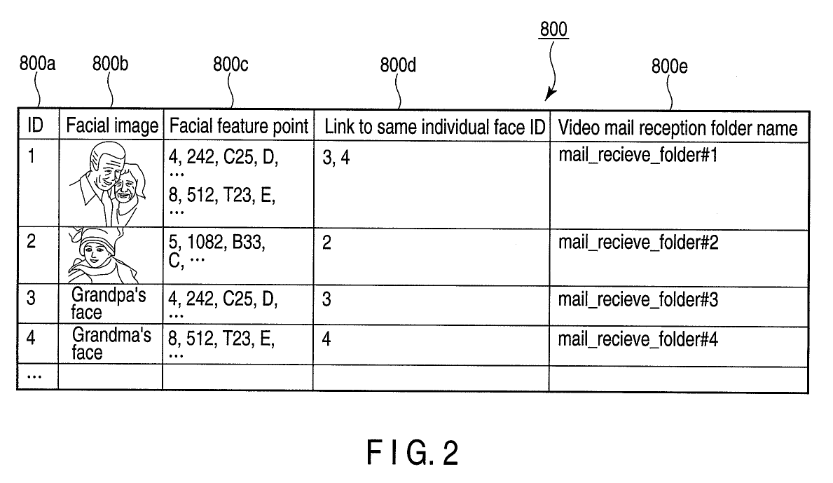

FIG. 2 is a view for explaining a specific example of the address management table 800. This address management table 800 is constituted of a column of an identifier 800a, a column of facial image data 800b, a column of a facial feature point 800c, a column of an identifier link 800d, and a column of a mail reception folder 800e.

In each row in the column of the facial image data 800b, bitmap data of a facial image (face image) of a user taken in by the cameral is registered. This bitmap data may be data obtained by eliminating background data around the facial image of the user (a background of the facial image may be set to a solid color like a blue background, a background image may be counterchanged with a still image additionally acquired by a digital camera, or a background image may be counterchanged with a moving picture additionally acquired by a digital video camera).

In each row in the column of the facial feature point 800c, each code that recognizes a feature point of each face of one or more users included in a registered facial image is written.

A unique ID number incremented in order of registration is written in each row in the column of the identifier 800a. This unique ID is assigned to each facial image in the same row.

In each row in the column of the identifier link 800d, one or more ID numbers assigned to faces of the same user can be written.

In each row in the column of the mail reception folder 800e, a folder name associated with the identifier 800a in the same row can be given. Specifically, a folder name “mail_receive_folder#1” is given to a folder belonging to the mail reception folder 800e in a row where the identifier 800a has an ID=1, a folder name “mail_receive_folder#2” is given to a folder in a row having an ID=2, a folder name “mail_receive_folder#3” is given to a folder in a row having an ID=3, and a folder name “mail_receive_folder#4” is given to a folder in a row having an ID=4.

Likewise, a folder name associated with an ID is written in each row in the column of the mail reception folder 800e.

In the mail reception folder 800e, not only video contents (a video mail) themselves are registered but also a shortcut (a pointer) to contents, an URL (a description that specifies a location where information is present on the Internet and a method of acquiring this information), and others can be written.

A folder in the mail reception folder 800e has a function like an electronic mail office box. For example, when a video mail from a grandchild is registered in a folder having a name “mail_receive_folder#1”, a user having an ID=1 (“grandpa” and “grandma”) is informed of reception of this mail. Additionally, when links to users having the same faces (“grandpa” having an ID=3 and “grandma” having an ID=4) are provided in the row of the ID=1, “grandpa” having the ID=3 and “grandma” having the ID=4 are individually informed of reception of the mail. “Grandpa” and/or “grandma” who have received this information can see the video mail from the grandchild registered in the folder having the name “mail_receive_folder#1”.

In the mail system using the address management table 800 having the above-described structure, a facial image corresponds to an address that can be seen by a user, and an ID corresponds to an address in a device. When one facial image includes faces of two or more users, addresses of the individual faces are also registered (feature points of the individual faces are separately registered). Then, mails for a plurality of faces (e.g., “grandpa” and “grandma”) are put into a folder of a user himself/herself alone (e.g., “grandpa”), thereby facilitating confirmation of mails.

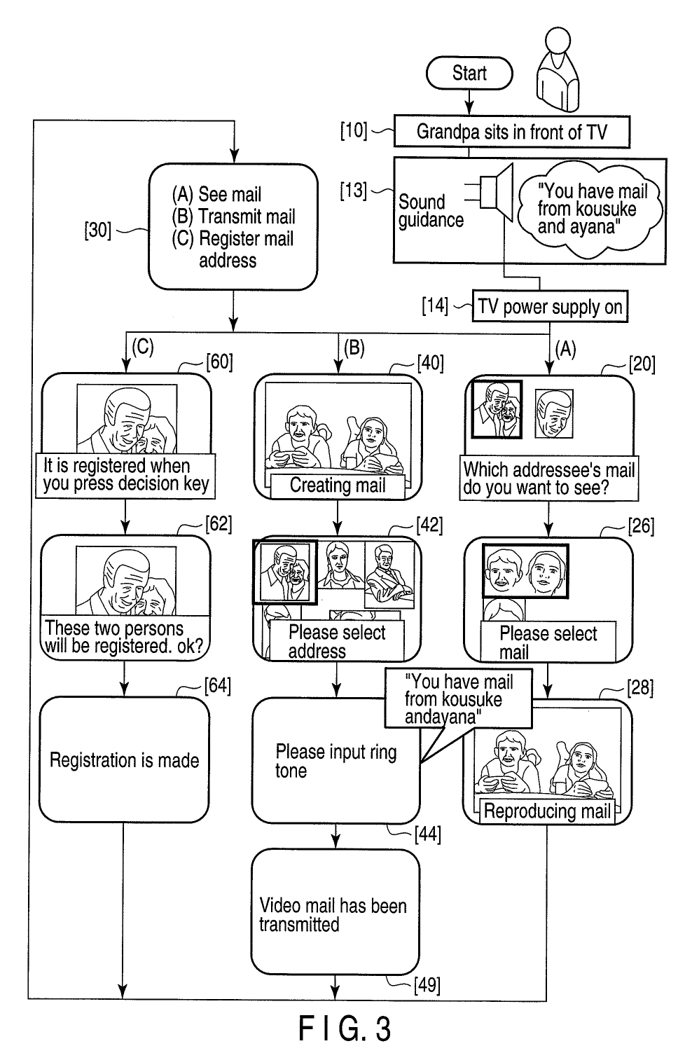

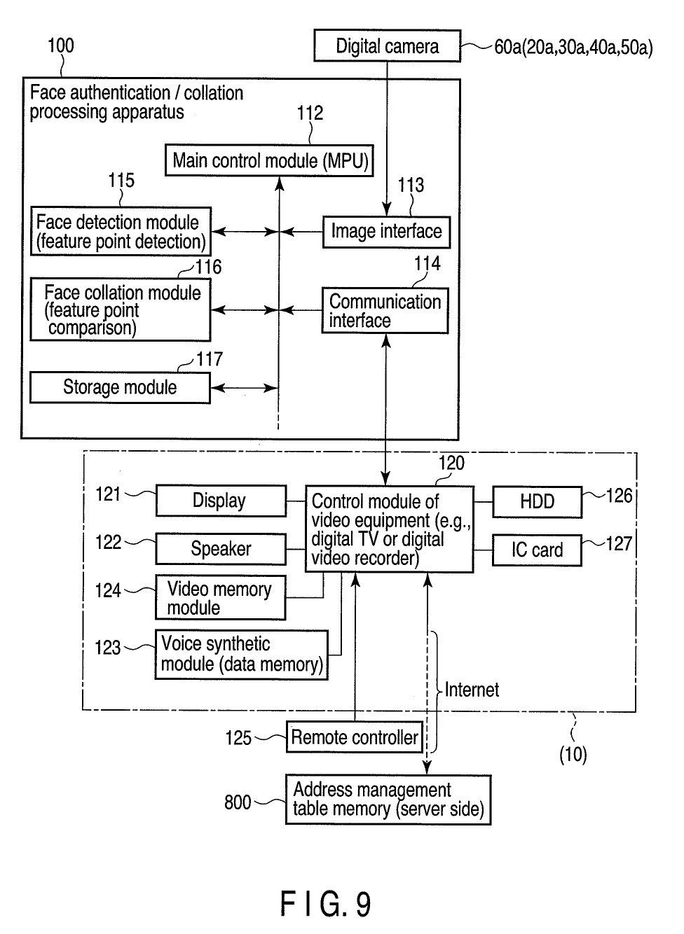

FIG. 3 is a view for explaining an outline of a flow of a user operation in a mail system utilizing the address management table 800 depicted in FIG. 2. In the processing depicted in FIG. 3, face authentication processing is executed by the later-described face authentication/collation processing apparatus 100 shown in FIG. 9, and any other processing is executed by a later-explained control module 120 of a video equipment depicted in FIG. 9.

For example, when “grandpa” registered in the address management table 800 with the ID=3 sits in front of the camera of the TV 10 that is in a standby mode (BLOCK [10]), the face authentication/collation processing apparatus 100 included in the TV 10 starts face authentication processing of “grandpa”. Further, a code associated with a feature point of a face obtained by this face authentication processing is sought from a code group of the feature point 800c in the address management table 800. If a corresponding code is found, it can be understood that “grandpa” registered with the ID=3 is in front of the TV 10. If a corresponding code cannot be found, the standby mode continues until another registered user (e.g., grandma having the ID=4) appears in front of the camera or a power supply of the TV 10 is turned on.

When it has been revealed that “grandpa” registered with the ID=3 is present, the ID=3 is linked with the ID=1 in the identifier link 800d in the address management table 800, and a video mail from grandchildren (e.g., “Kousuke” and “Ayana”) is registered in the video mail reception folder “mail_receive_folder#1” having the ID=1, and a ring tone “you have a mail from Kousuke and Ayana” is added to this video mail. In this case, an audio guidance message “you have a mail from Kousuke and Ayana” is output from a speaker of the TV 10 (BLOCK [13]), and the power supply of the TV 10 is turned on (BLOCK [14]).

In a screen of the TV 10 which has been turned on, a facial image of “grandpa and grandma” registered with the ID=1 in the address management table 800 and a facial image of “grandpa” registered with the ID=3 are displayed. At this time, a guidance text “Which addressee's mail do you want to see?” is also displayed by default (BLOCK [20]). “Grandpa” who is sitting in front of the TV 10 points a cursor on the facial image of “grandpa and grandma” by manipulating a non-illustrated cursor key in a remote controller which is in his hand, and presses a non-illustrated Enter key (a decision key) in this remote controller to decide the selection of “grandpa and grandma” (BLOCK [20]). Then, in the column of the video mail reception folder name 800e in the address management table 800, thumbnails of video mails from grandchildren (“Kousuke” and “Ayana”) registered in the folder “mail_receive_folder#1” in the row having the ID=1 are displayed in the TV 10.

At this time, when another video mail is present in the folder “mail_receive_folder#1”, a thumbnail of this video mail is displayed at the same time, and a guidance text “please select mail” is also displayed by default (BLOCK [26]). At this time, since there was the audio guidance message “you have mail from Kousuke and Ayana” in BLOCK [13], “grandpa” can select a thumbnail including faces of the grandchildren (“Kousuke” and “Ayana”) without question. That is, “grandpa” points the cursor on the facial image of “Kousuke and Ayana” by operating the cursor key in the remote controller which is in his hand and presses the Enter key in the same remote controller to decide the selection of “Kousuke and Ayana” (BLOCK [26]). Then, the video mail from “Kousuke and Ayana” registered in the folder “mail_receive_folder#1” can be reproduced in the TV 10 (BLOCK [28]).

When reproduction of the video mail is finished, the current screen is changed to an operation menu screen (BLOCK [30]). When a user again wants to see the same video mail or wants to see a different mail in the same folder, “(A) See mail” is selected from a displayed menu by manipulating the cursor key in the remote controller, and the Enter key is pressed. Then, the respective pieces of processing from BLOCKs [20] to [28] are again executed. In these pieces of processing, a user can see a different mail registered in, e.g., the folder “mail_receive_folder#3” in the row having the ID=3.

In the above-described operation, “grandpa” can see contents of the mail by operating the cursor key and the Enter key in the remote controller while confirming a facial image he knows, and a keyboard operation is no longer required.

In the operation menu screen (BLOCK [30]), when “(B) Transmit mail” is selected by operating the cursor key in the remote controller and the Enter key is pressed, respective pieces of processing from BLOCKs [40] to [49] are executed. That is, when the grandchildren as senders of a mail (“Kousuke” and “Ayana”) record a mail for “grandpa and grandma” in front of the camera and recording is finished, data of an image and audio acquired in this recording becomes one video mail file (BLOCK [40]). It should be noted that contents of this video mail file may be a still image acquired by a digital camera or a still image taken in by a scanner.

When this video mail file (contents of the mail) is brought to completion, thumbnails of faces registered in each column of the facial image 800b in the address management table 800 depicted in FIG. 2 are displayed in the screen, and a guidance text “Please select address” is displayed by default (BLOCK [42]). “Kousuke” or “Ayana” whose is a sender of the mail points the cursor in the remote controller on, e.g., the facial image of “grandpa and grandma”, and presses the Enter key in the same remote controller to decide the selection of “grandpa and grandma” (BLOCK [42]). Then, the audio message “you have a mail from Kousuke and Ayana” is recorded in accordance with an audio guidance message “please record a ring tone”, and this recording is registered in the same video mail file as the ring tone (BLOCK [44]). Then, the video mail file having the ring tone “you have a mail from Kousuke and Ayana” added thereto is transferred to the server 80 depicted in FIG. 1 (BLOCK [49]), and it is registered in the folder “mail_receive_folder#1” in the column of the video mail reception folder name 800e in the address management table 800. In this manner, transmission of the video mail can be completed without inputting text through a keyboard.

In the above-described operation, “Kousuke” and “Ayana” can transmit the video mail by just operating the cursor key and the Enter key in the remote controller while confirming the facial images of “grandpa” and/or “grandma” that they know, and a keyboard operation is no longer required.

In the operation menu screen (BLOCK [30]), when “(C) Register mail address” is selected by operating the cursor key in the remote controller and the Enter key is pressed, respective pieces of processing from BLOCKs [60] to [64] are executed. That is, for example, two persons, i.e., “grandpa” and “grandma” are in front of the camera, and face recognition of both these persons is executed by the face authentication/collation processing apparatus 100. Then, the facial image of the two persons, i.e., “grandpa and grandma” is displayed in the screen of the TV 10, and a character guidance “It is registered when you press decision key” is displayed by default (BLOCK [60]). When “grandpa” or “grandma” presses the Enter key (the decision key) in the non-illustrated remote controller, a character guidance “These two persons are going to be registered. Is it OK?” is displayed for confirmation (BLOCK [62]). If there is no problem, the Enter key (the decision key) is again pressed. Then, facial bitmap data of “grandpa and grandma” is registered in the row having the ID=1 in the column of the facial image 800b depicted in FIG. 2, and a feature point code of a face of “grandpa” and a feature point code of a face of “grandma” are written in this row. Further, the video mail folder “mail_receive_folder#1” having “grandpa and grandma” as an addressee is set in the address management table 800 depicted in FIG. 2. (At the beginning, the column of the link 800d for the same individual face may be blank. Each row of the row of this link is appropriately filled later.) In this manner, initial registration of “grandpa and grandma” is completed (BLOCK [64]).

In the above-described operation, “grandpa” or “grandma” can register himself/herself by operating the cursor key and the Enter key in the remote controller while confirming the facial image that he/she knows, and a keyboard operation is no longer required.

A series of processing in BLOCKs [10] to [20] in FIG. 3 may be as follows as an example of a method of informing a user subjected to face authentication that “a mail has arrived”. That is, the following processing may be carried out.

01) When a person who has received a mail (a user subjected to face recognition) is watching a TV screen, a TV power supply is automatically turned on, and a message associated with the incoming mail is displayed. This message is not restricted to an example in BLOCK [20] in FIG. 3, and it may include information indicative of discovery of contents recommended by the firm 90 in FIG. 1, a video letter from the firm 90, or information from a site on the Internet.

02) Before or after turning on the power supply, audio guidance associated with a person who is watching the TV screen (the user subjected to face recognition) is executed.

03) Specifically, a mail sender registers a calling voice in a video mail file of his/her face, and a call, e.g., “you have a message from Taro” is output in this voice when a mail recipient is in front of the TV.

04) At this time, when a plurality of persons are watching the TV screen (a plurality of persons are subjected to face authentication), an object person of the call can be selected. (For example, even if “grandpa” and “grandma” are in front of the TV, an object person of the call may be set to “grandpa” only. This can be realized by registering audio data “a calling voice for grandpa” in the mail reception folder having the ID=1 in the address management table 800 depicted in FIG. 2.) Further, contents that can be comprehensively recommended for persons who are watching a screen, a relevant video letter, information from a site, and others can be also displayed. (For example, when users subjected to face authentication are “grandpa” and “grandma”, contents which can be recommended for both the persons without being lopsided to one of them, e.g., a hot spring trip guide or an introduction of a good noodle restaurant can be displayed.)

05) When seeing contents of a message of a transmitted mail, a previously registered operation (e.g., movement of a hand or fingering of a user who has registered his/her facial image) can be utilized in place of a password. (For example, when a picture outline of a V-like shape formed by an index finger and a middle finger of the user reciprocates in the lateral direction for three times in one or two seconds, this motion is accepted as a password.) In this case, when a different person who should be prevented from seeing a message is also in front of the TV besides users subjected to face authentication, setting a password is helpful. When, e.g., a motion of a hand or fingers of a user is registered as a password, keyboard input is not required for setting the password.

06) It is possible to configure that contents of a message can be seen only when a person who is watching the screen has a wireless key. (In this example, the wireless key means a key having the same function as a keyless entry system of a car. A call using a mobile phone may be utilized in place of this key.) Alternatively, an operation of seeing contents of a message may be accepted only from a remote controller which is in a hand of a user subjected to face recognition and has a specific identification code set thereto (an operation from any other remote controller is not accepted).

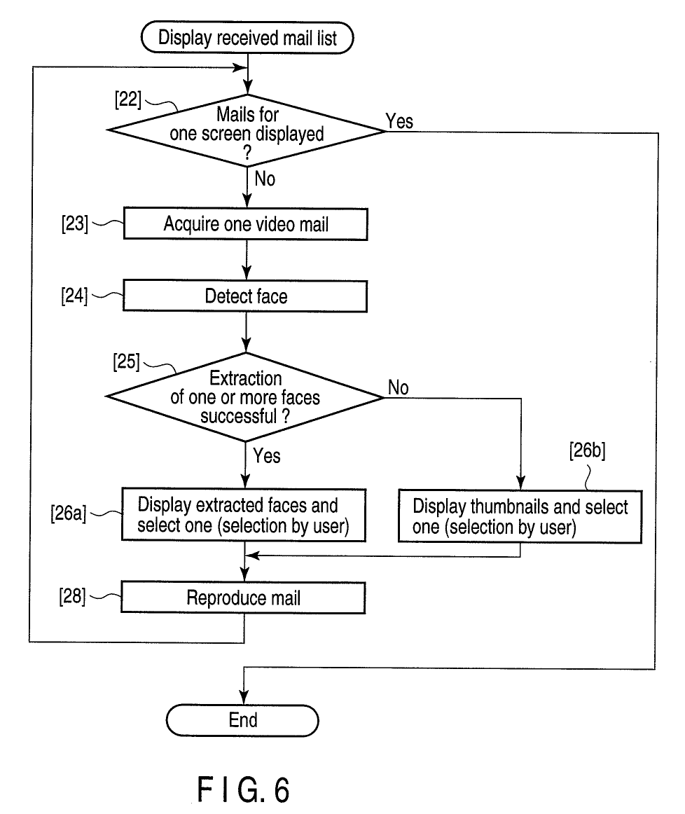

07) As a list of received mails, faces extracted from received video mail may be aligned. When faces cannot be extracted from video mails, thumbnails of facial images of users subjected to face authentication can be output like the example of BLOCK [20] in FIG. 3 (the detail will be described later with reference to FIG. 6.)

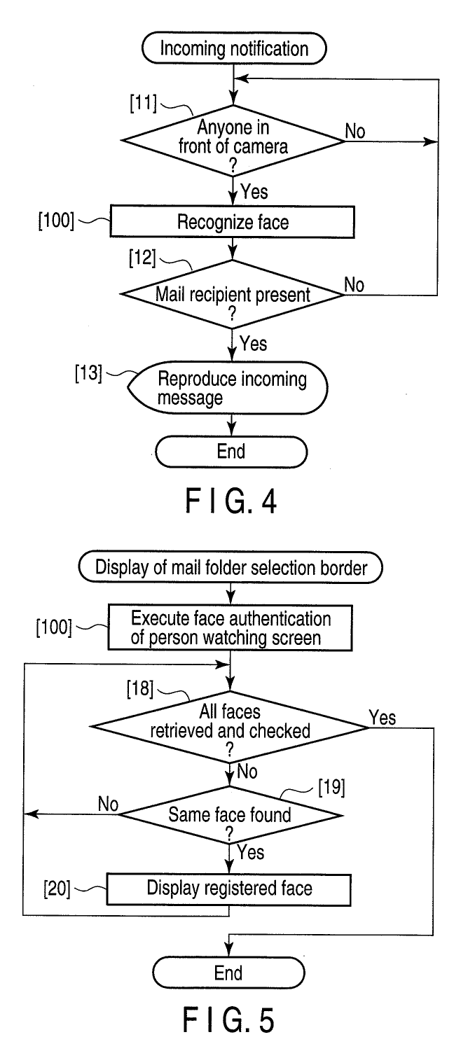

FIG. 4 is a view for explaining an example of arrival notification processing. This processing corresponds to processing of BLOCKs [10] to [14] in FIG. 13. That is, when someone is in front of the camera of the TV 10 which is in the standby mode (BLOCK [11—YES]), the built-in face authentication/collation processing apparatus 100 in the TV 10 starts face authentication processing of this person, i.e., a user (BLOCK [100]). Further, a code group of the feature point 800c in the address management table 800 is searched for a code associated with a feature point of a face obtained by the face authentication processing. When a corresponding code is found (BLOCK [12—YES]), an incoming message of a video mail registered in the video mail reception folder associated with an ID of this person is reproduced (BLOCK [13]). When the corresponding code is not found (BLOCK [12—NO]), the standby mode continues until someone having the corresponding registered code appears in front of the camera BLOCK [11—YES]. The detail of the face authentication processing BLOCK [100] will be described later.

It should be noted that, when casting aside a possibility that strangers may see mails in a situation which is 100% unreliable based on face authentication using machine processing alone is desirable, a setting that another key is provided and a message or the like of a mail can be seen only in a situation where a this key is present can be formed in addition to the face authentication processing.

Specifically, a mail may be reproduced only when a user who is in front of the TV 10 has a wireless key (which is like a keyless entry system of a car, and a mobile phone or a remote controller having a special code set therein may be used in place of this wireless key) and a specific key code is accepted from this wireless key. In this case, when a receiver (not shown) of the wireless key is connected with the control module 120 depicted in FIG. 9 and the control module 120 executes “key matching processing of the wireless key”, whereby unspecified persons can be prevented from receiving or opening a mail.

Alternatively, a previously registered operation (e.g., a motion of a hand of a user) can be utilized as another key in place of the wireless key (or with the wireless key). For example, when a picture of a hand of a user holding the wireless key or the remote controller reciprocates (in an up-and-down direction, a left-and-right direction, or an oblique direction) for a predetermined number of times within a fixed time, this can be accepted as key match.

FIG. 5 is a view for explaining an example of display processing of mail folder choices. This processing corresponds to processing in BLOCK [20] in FIG. 3. First, for example, information of a face of a person (a user) who is watching the screen of the TV 10 in front of the camera 60a of the recorder 60 associates with the TV 10 in FIG. 1 is acquired and authenticated. That is, the face of the user is recognized and compared with authentication information (facial information) registered in the address book to check whether this information is registered (BLOCK [100]).

A user who is in front of the camera 60a may be changed to a different person, another person may appear to increase the number of users, or some of a plurality of persons who are in front of the camera 60a may leave the camera to decrease the number of users. Therefore, even if face authentication is performed previously (e.g., BLOCK [100] in FIG. 4), face authentication BLOCK [100] in FIG. 5 is executed. However, if original data (bitmap data obtained by taking (capturing) a facial image of a user from the camera) used for face authentication (processing) is the same as that utilized for previous face authentication, the processing of the face authentication BLOCK [100] in FIG. 5 can be skipped to use a result of the previous face authentication (e.g., BLOCK [100] in FIG. 4.)

When face authentication of a user (e.g., “grandpa”) who is in front of the camera 60a is finished and its feature point data is obtained, a facial image registered in the address management table 800 in FIG. 2 is retrieved based on the obtained feature point data to check whether the feature points coincide with each other (BLOCK [18]). In the first check (BLOCK [18—NO]), if a facial image having a matched feature point (e.g., “grandpa and grandma” with the ID=1 which includes a part matching with the feature point of the “grandpa”) is found (BLOCK [19—YES]), a thumbnail of this facial image (a facial image having the ID=1 in the example depicted in FIG. 2) is displayed in the screen of the TV 10 (BLOCK [20]).

Likewise, in the next check, if a facial image having a matched feature point (“grandpa” having the ID=3 which matches with the feature point of “grandpa”) is found (BLOCK [19—YES]), a thumbnail of this facial image (a facial image having the ID=3 in the example depicted in FIG. 2) is additionally displayed in the TV 10 (BLOCK [20]).

When the face retrieval BLOCK [18] and the registered face display BLOCK [20] are completed with respect to all the facial images 800b registered in the address management table 800 in FIG. 2 (BLOCK [18—YES]), processing depicted in FIG. 5 is terminated. As a result, such a plurality of thumbnails as depicted in BLOCK [20] in FIG. 3 is displayed in the screen of the TV 10. The thus displayed respective thumbnails become choices for a corresponding mail folder. Taking contents of registration in the address management table 800 in FIG. 2 as an example, if the facial image “grandpa and grandma” having the ID=1 is selected, the mail folder “mail_receive_folder#1” is selected. If the facial image “grandpa” having the ID=3 is selected, the mail folder “mail_receive_folder#3” is selected.

FIG. 6 is a view for explaining an example of received mail list display processing. This processing corresponds to processing in BLOCK [20] and subsequent steps that follows the processing of BLOCKs [10] to [14] in FIG. 3. After reception of a video mail, if this mail is not displayed yet (BLOCK [22—NO]), one video mail is obtained from a corresponding video mail reception folder in the address management table 800 in FIG. 2 (BLOCK [23]).

This video mail is partially reproduced (for example, a part corresponding to a period from 20 seconds to 30 seconds after start of reproduction of a video is reproduced at a rate of, e.g., 10 frames per second), and this reproduced video frame is searched for a facial image of a person. If a facial image can be found, this facial image data is taken out, and authentication processing is executed with respect to this facial image in BLOCK [24] to check whether this facial image matches with a feature point of any face registered in the address management table 800 in FIG. 2. If one or more facial images which coincide with feature points of faces registered in the address management table 800 are consequently found, it is determined that one or more faces were extracted (BLOCK [25—YES]), and their facial images are displayed (BLOCK [26a]).

When the number of the extracted face is one, a video mail file associated with this face is taken out from the address management table 800 to be reproduced (BLOCK [28]). When, a plurality of faces extracted, these respective faces are displayed in the TV, and a user (a mail recipient) is prompted to select one from the displayed faces (BLOCK [26a]). When the user specifies a specific face from the plurality of displayed faces by operating the cursor in the remote controller and presses the Enter key to select this face, a video mail file associated with this face is taken out from the address management table 800 to be reproduced (BLOCK [28]).

When any face cannot be selected from the video mail at all by the above-described operation (BLOCK [25—NO]), a thumbnail of a registered facial image having an ID associated with a file of this video mail (e.g., the facial image of “grandpa and grandma” having the ID=1 registered in the address management table 800 in FIG. 2) is displayed (BLOCK [26b]).

When one thumbnail alone is displayed, a video mail file associated with a face in this thumbnail is taken out from the address management table 800 to be displayed (BLOCK [28]). When there are a plurality of displayed thumbnails, they are displayed in the TV, and a user (a mail recipient) is prompted to select one from the displayed thumbnail (BLOCK [26b]). When the user specifies a specific thumbnail in the plurality of displayed thumbnails by operating the cursor in the remote controller and presses the Enter key to select this thumbnail, and a video mail file associated with a face in this thumbnail is taken out from the address management table 800 to be reproduced (BLOCK [28]).

It should be noted that, when facial image data is obtained by processing in BLOCK [24] in advance, a thumbnail to be displayed in BLOCK [26b] can be created from this facial image data.

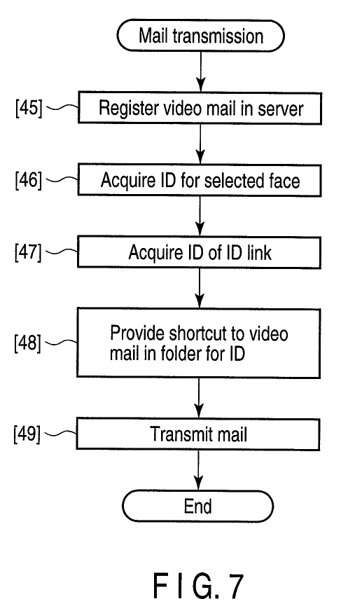

FIG. 7 is a view for explaining an example of mail transmission processing. This processing corresponds to processing of BLOCKs [40] to [49] in FIG. 3. That is, a video mail which should be transmitted is registered in the video mail reception folder in the address management table 800 of the video letter server 80 depicted in FIG. 1 (BLOCK [45]). An ID corresponding to a name of the video mail reception folder where this registration is carried out (an ID associated with a face selected in BLOCK [42] in FIG. 3) is acquired from the address management table 800 in FIG. 2 (BLOCK [46]). For example, assuming that a video mail is registered in the folder “mail_receive_folder#1”, the ID=1 associated with this folder name is acquired (BLOCK [46]).

If a link to an ID likewise indicative of the same individual face is provided to a row of this ID=1, an ID of this link is acquired (BLOCK [47]). For example, assuming that “grandpa and grandma” is registered with the ID=1, the same “grandpa” is registered with the ID=3, and the same “grandma” is registered with the ID=4, the ID=3 and the ID=4 are written in the row of the ID=1 in the column of the link 800d to the same individual face ID. In this case, when the ID=1 is acquired in BLOCK [46], the ID=3 and the ID=4 are obtained in BLOCK [47].

A shortcut to the registered video mail is provided to folders (“mail_receive_folder#3 and “mail_receive_folder#4”) associated with the thus obtained one or more IDs (the ID=3 and the ID=4 linked to the ID=1), (BLOCK [48]). This shortcut can be realized by setting to a corresponding folder a file pointer indicative of a file storage position of a video mail which should be transmitted or writing a URL which specifies a location where a file of the video mail is present on the Internet and an acquisition method for this file. Further, a mail is transmitted to recipients, i.e., “grandpa and grandma” having the ID=1, “grandpa” having the ID=3, and “grandma” having the ID=4 (BLOCK [49]).

Based on the above-described processing, a user (a mail transmitter) can transmit a mail without operating a keyboard.

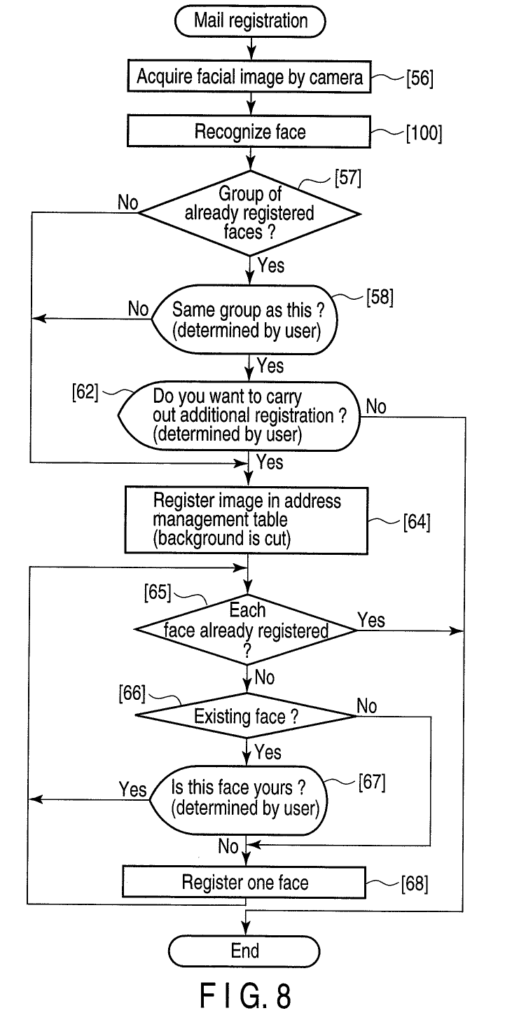

FIG. 8 is a view for explaining an example of mail registration processing. This processing is processing corresponding to processing of BLOCKs [60] to [64] in FIG. 3. In this example, it is assumed that faces of “grandpa and grandma” having the ID=1 and a face of “child” having the ID=2 have been already registered in the address management table 800 in FIG. 2, and subsequent registration processing will be described. First, a facial image of a user (e.g., “grandpa”) is acquired by the camera 60a in FIG. 1 (BLOCK [56]). Subsequently, the acquired face is recognized to extract its feature point in BLOCK [100], and the extracted feature point is encoded.

When the feature point of the recognized face of “grandpa” coincides with a feature point of a face of “grandpa” in the faces of registered “grandpa and grandma” having the ID=1 (BLOCK [57—YES]), a facial image of registered “grandpa and grandma” having the ID=1 is displayed in the TV 10, and an inquiry “(do you belong to) the same group as this?” is output in the form of text and/or audio (BLOCK [58]). Here, a judgment can be made by the user without leaving the operation to the machine, thereby enhancing an accuracy of face registration.

When a user in front of the TV 10 (grandpa) selects a pictorial symbol of non-illustrated “YES” by operating the remote controller which is in his hand and presses the Enter key (BLOCK [58—YES]), an inquiry “do you want to carry out additional registration?” is output in the form of text and/or audio (BLOCK [62]). When the user (grandpa) determines that “additional registration is not required” (BLOCK [62—NO]), a non-illustrated End key in the remote controller in his hand is pressed to terminate the processing in FIG. 8.

When the user (grandpa) determines that “additional registration is carried out” (BLOCK [62—YES]), “grandpa” subjected to face recognition is registered with the ID=3 in the address management table 800 in FIG. 2. Then, a facial image of “grandpa” is registered in the column of the facial image 800b in the row of the ID=3 in the address management table 800, a feature point code of the face of “grandpa” is written in the column of the facial feature point 800c in the same row, and a folder “mail_receive_folder#3” for “grandpa” -having the ID=3 is created in the column of the video mail reception folder 800e in the same row (this folder is empty in the first place). Furthermore, “3” indicative of the ID=3 is written in the column of the link 800d to the same individual face ID in the row of the ID=3 and, at the same time, “3” indicative of the ID=3 is written in the column of the link 800d to the same individual face ID in the row of the ID=1. As a result, “grandpa” having the ID=3 is linked to “grandpa and grandma” having the ID=1 including the same person.

It should be noted that a background image except a face is discriminated from a facial image when performing facial authentication in BLOCK [100], and hence the background image discriminated from the face can be cut at the time of registration of the facial image in BLOCK [64] (the background may be left in case of a face acquired outdoors having a good landscape, but cutting the background is desirable in case of a face acquired in a messy room). The cut background image region part can be filed with, e.g., pixel data of a blue color alone (in this case, the background is a solid blue background).

There is also a method of inserting an arbitrary image in a background image region to obtain facial image data. As this method, there is, e.g., a method of “extracting a facial image alone and combining the extracted facial image with a still picture additionally acquired by a digital camera or combining the same with a moving picture additionally acquired by a digital video camera”.

Specifically, for example, when a facial image is combined with bitmap data of an 8-bit plane to be brought to completion, a one-bit plane in the lowest layer is counterchanged with still picture data, and a 7-bit plane on a higher layer can be determined as facial image data of a user.

Alternatively, processing of counterchanging a background image with a moving picture additionally acquired by a digital video camera (or a computer graphic animation created by a personal computer) can be also executed. Specifically, when a facial image is formed of bitmap data of an 8-bit plane, a 1 to 4-bit plane in the lowest layer can be counterchanged with moving picture data, and a 5 to 7-bit plane in the higher layer can be determined as facial image data of a user.

When a feature point of a recognized face of “grandpa” does not coincide with a feature point of a face of “grandpa” in faces of registered “grandpa and grandma” having the ID=1 (BLOCK [57—NO]), or when a user himself/herself determines that they are strangers (e.g., brothers who resemble each other) by taking a closer look even though the machine recognizes that the feature points match with each other (BLOCK [58—NO]), this “grandpa” is a user who is not registered in the address management table 800, and hence a registering operation in BLOCK [64] is executed. When there is only one user to be registered, face registration is all terminated BLOCK [65—YES].

On the other hand, when a plurality of faces are included when face authentication is performed in BLOCK [100], the respective faces are registered one by one. That is, when all of the respective faces are not registered yet (BLOCK [65—NO]), whether each face is a face registered in the address management table 800 is checked (BLOCK [66]). When each face is not registered in the address management table 800 (BLOCK [66—NO]), an image, a feature point, a link ID, and a folder name of this face are registered in a row of a new incremented ID (BLOCK [68]).

When a user determines “strangers who resemble each other” by taking a closer look at a face image (BLOCK [67—NO]) even though the machine determines that this face is registered in the address management table 800 (BLOCK [66—YES]), an image, a feature point, a link ID, and a folder name of this face are registered in a row of a new incremented ID (BLOCK [68]). Here, the user can likewise make a judgment without leaving the operation to the machine, thereby improving an accuracy of face registration. It should be noted that a background can be appropriately cut in face registration in BLOCK [68].

When the machine determines that this face is registered in the address management table 800 (BLOCK [66 —YES]) and the user looks this facial image to determine that “this facial image is mine” (BLOCK [67—YES]), the processing in BLOCK [68] is skipped to avoid redundant registration. When there is no user whose face should be registered, face registration is all terminated (BLOCK [65—YES]).

FIG. 9 is a view for explaining a structural example of the face authentication/collation processing apparatus. The face recognition processing BLOCK [100] in FIGS. 4, 8, and others is executed by the face authentication/collation processing apparatus 100, and any other processing is executed by the control module 120 in the video equipment, respectively. The face authentication/collation processing apparatus 100 is formed of a main control module 112, an image interface unit 113, a communication interface unit 114, a face detection module 115, a face collation module 116, a storage module 117, and others. It should be noted that a collation database is stored in the storage module 117.

Although not shown, the main control module 112 is formed of an MPU having, e.g., a program memory or a work memory, and the MPU executes a program (firmware) stored in the program memory to realize various functions.

The image interface unit 113 is an interface that is used to input an image (bitmap data having a resolution associated with the number of pixels of a frequently utilized camera) acquired by the camera 60a (or 20a, 30a, 40a and 50a) in FIG. 1 to the face authentication/collation processing apparatus 100. Moreover, the communication interface unit 114 is utilized for communication with the control module 120 of the video equipment. The face authentication/collation processing apparatus 100 executes authentication or collation of a facial image captured from the camera 60a in response to a request from the control module 120, and sends results of the processing to the control module 120 through the interface unit 114 (outputs an authentication result and a collation result).

The face collation module 116 executes collation processing of a facial image detected by the face detection module 115 and a facial image of a specific person stored in the collation data base (a data base including information corresponding to the ID 800a, the facial image 800b, and the facial feature point 800c in FIG. 2) in the storage module 117.

The face detection module 115 detects a facial image from a person from an image acquired by the camera 60a based on detection processing. At this time, the face detection module 115 appropriately changes a gray scale or contrast of acquired image data and executes, e.g., edge enhancement processing to sharply define edges (contours of face, contours of eyes, nose and mouth, and other features) of a facial image that appears in the image data, thereby facilitating detection of a pattern of the face including eyes, nose, mouth, and other features. As a result, a boundary between a region where the facial image is present and a peripheral region where a background image is present becomes clear, thus facilitating processing of deleting a background image portion.

Additionally, in, e.g., a two-dimensional coordinate value having an upper left corner of rectangular region including a facial image as an original point, a two-dimensional region FA including the facial image is determined. In this two-dimensional region FA of the facial image, the face detection module 115 obtains a correlation value of a facial pattern in the region FA and standard facial patterns prepared in advance while moving a face detection template (one or more standard facial patterns prepared in advance). Then, a correlation value of a feature point (e.g., eyes, nose, or mouth) of the facial pattern at a specific position (x, y) represented in the two-dimensional coordinate with respect to the standard pattern is encoded. A result of this encoding is written in the facial feature point 800c in the address management table 800 in FIG. 2. A row of the table where the correlation value code is written is a row where an original facial image whose correlation value of the face has bee obtained is registered (e.g., the correlation value code of the feature point of the facial image registered in the row having the ID=1 is written in the row having the ID=1).

Now, it is assumed that a plurality of standard facial patterns of different sizes which are prepared in advance are gs(i, j) and a correlation of each standard facial pattern gs(i, j) and a local region (a region of, e.g., eyes, nose, or mouth) in an image f(x, y) in the two-dimensional region FA is Ms(x, y). In this case, for example, the correlation Ms(x, y) in the local region can be obtained as follows:

Ms(x,y)=Σf(x+i,y+i)gs(i,j/{Σf(x+i,y+i)·Σgs(i,j)} (1)

Here, the standard facial patterns gs(i, j) of different sizes can be created by, e.g., averaging previously collected facial patterns of a predetermined size.

As a method of obtaining the correlation Ms, a known method can be adopted. As an example, there is “a verification medium issuing apparatus and an identity collating apparatus” disclosed in Japanese Patent Application Publication (KOKAI) 2003-108935 (KOKAI) for reference (paragraphs 0043 to 0057 in this publication disclose a specific example that can be utilized in face authentication/collation processing).

The control module 120 of the video equipment includes a display 121 that reproduces a facial image or a video mail, i.e., displays a picture and character information, a speaker 122 that outputs audio guidance for mail arrival or audio output in a video mail, a voice synthetic module 123 that has a data memory for voice guidance output from the speaker 122 and combines an audio signal from audio data in this memory, a video memory module 124 in which thumbnails, dialogs, or pictorial symbols that are displayed in the display 121 are spread, a remote controller 125 that accepts user operations, a hard disk drive (HDD) 126 that stores video letters and any other information, a memory (an IC card) 127 that stores video letters and any other information, and others. This control module 120 instructs the face authentication/collation processing apparatus 100 to execute face authentication/collation processing, and sequentially carries out the “user operation”, the “arrival notification processing”, the “mail folder choice display processing”, the “received mail list display processing”, the “mail transmission processing”, and the “mail registration processing” explained in conjunction with FIGS. 3 to 8 upon receiving a processing result. The face authentication/collation processing apparatus 100 can access the address management table 800 of the video letter server 80 through the Internet or a home network to appropriately take contents in the table or appropriately rewrite the contents in the table (additional registration or deletion of unnecessary information).

It should be noted that functions of the apparatus 100 and the control module 120 in FIG. 9 can be incorporated into the electronic devices in FIG. 1 (the TV 10, the TV 20, the PC 30, the game console 40, the mobile phone 50, and the recorder 60), respectively. However, a face authentication throughput capacity may vary depending on each device. For example, the digital TV 10 or the PC 30 can recognize individual faces even though a plurality of faces are displayed in one screen, and the game console 40 or the mobile phone 50 can recognize a face of one user alone in front of the camera each time.

### Brief Account of Embodiment

<[a]> Mail Address (=face) Registration Method 1a:

1a] A face acquired by a camera disposed to a device is registered as an address (a destination of registration is a device main body (e.g., an HDD) or a server on the Internet);

2a] When a plurality of faces are acquired by the camera at a time in address registration, individual faces are recognized, and the individual faces are registered as address data, respectively. However, as an address choice, an image including a plurality of faces may be used;

3a] When an image including a plurality of persons is acquired, it becomes an address for concurrent transmission for multiple persons; and

4a] When registering a facial image, an arbitrary background is used (a messy room as a background can be hidden).

<[b]> Mail Transmission Method (a face of a mail recipient is selected):

1b] A plurality of arbitrary faces are selected as addresses of video letters from a plurality of faces, and the selected faces are registered;

2b] A domestic device acquires an address list of video letters from a server on the Internet (when the address list is used by family members);

3b] A picture taken by a camera disposed to a device as well as other contents (e.g., a picture taken by a digital camera) can be added to each video letter; and

4b] Video letters are recorded in a device (e.g., an HDD) or a server on the Internet.

<[c]> Mail Arrival Notification Method (Face Recognition):

1c] When a person having an incoming mail is watching a screen (face recognition), a power supply is automatically turned on to display a corresponding message (The message means discovery of recommended contents, a video letter, or information from a site);

2c] When the power supply is turned on, a corresponding message is displayed for a person who is watching the screen (in face recognition);

3c] A transmitter registers a calling voice with respect to his/her face, and a mail recipient is called in this voice when he/she is in front of a TV (e.g., “you have a message from Taro”);

4c] At this time, if a plurality of persons are watching the screen, an object person can be selected (Alternatively, contents that can be comprehensively recommended, a relevant video letter, or information from a site are displayed for the persons who are watching the screen);

5c] When seeing contents of a message, an operation registered in advance (e.g., a motion of a hand) is used in place of a password;

6c] Contents of a message can be seen only when a person is watching the screen and has a wireless key (The wireless key: a key like a keyless entry system of a car or a mobile phone can be used in place of the wireless key); and

7c] Faces extracted from video mails are aligned as a list of received mails (When faces cannot be extracted, thumbnails are output).

### Effects of Embodiment 1

The following effect can be provided by a camera disposed to, e.g., a TV, a video mail system, and face recognition.

11] A person who cannot use a keyboard can receive the full benefit of mails;

12] Mails can be seen or transmitted through not only a mobile phone or a PC but also a TV and others (Any environment can be adopted);

13] Mails can be transmitted easily like making phone calls (Both advantages of phones and advantages of mails can be provided); and

14] A plurality of persons, e.g., family members can see or transmit mails.

### Effects of Embodiment 2

A camera and face recognition means can provide the following effects.

21] Even aged persons who are bad at typing can transmit a mail using a video to grandchildren (although mails have merits that cannot be observed in phones, aged persons have difficulty in using PCs), and even grandchildren or disabled persons who cannot use PCs can transmit mails using videos;

22] A message using a video can be readily left even in case of an urgent need;

23] Text does not have to be typed when registering an address (a face serves as an address); and

24] A feeling of security is provided since a face serves as an address, and address errors can be reduced because of high legibility.

### Effects of Embodiment 3

31] Even aged persons who are bad at typing can transmit a mail using a video to grandchildren (although mails have merits that cannot be observed in phones, aged persons have difficulty in using PCs), and Even grandchildren or disabled persons who cannot use PCs can transmit mails using videos;

32] A message using a video can be readily left even in case of an urgent need;

33] Text does not have to be typed when registering an address (a face serves as an address);

34] A feeling of security is provided since a face serves as an address, and address errors can be reduced because of high legibility; and

35] A feature point of a face serves as a mail address (=a user himself/herself) and also as a key for a mail reader (a user himself/herself alone can read (a wireless key or an operation password can complement security as required)).

### Effects of Embodiment 4

41] Since a face recognition ability of a person (an adult with considerable experience of life in particular) usually overtakes a face recognition capability based on mechanical processing alone, a mail can be prevented from being transmitted to a wrong person (a stranger unconnected with the intended mail recipient) except a case where each of twins who resemble each other is taken for the other (a problem like erroneous transmission to an unconnected stranger hardly occurs in case of a mistake of twins);

42] Users who have difficulty in operating a keyboard (aged persons who are bad at operating the latest electronic devices in particular) can receive the full benefit of the face recognition processing as long as they can perform simple operations like those of a remote controller; and

43] Further, since face registration can be carried out in actual use without operating a keyboard, convenience of the face recognition processing can be utilized for mail communication even if “a face and a mail address of a person” are not registered in advance.

### Applications of Embodiment and Invention

<I> There is provided an information processing method including: taking facial image data of a user (BLOCK [56]); extracting a feature point of a face of the user from the facial image data and encoding the feature point (BLOCK [100]); and associating the facial image data (800b in FIG. 2: e.g., “grandpa and grandma”) with a unique identifier (800a in FIG. 2: the ID=1 which is sequentially given) and/or the encoded feature point (800c in FIG. 2) to be registered in an address management table (800 in FIG. 2, BLOCK [64]).

<II> There is provided the information processing method, wherein the address management table (800 in FIG. 2) includes a column of the identifier (800a), a column of the facial image data (800b), a column of the feature point (800c), and a column of an identifier link (800d) and, when the facial image data (800b) having a commonality (e.g., a commonality of a “grandpa's face” or a “grandma's face”) in the feature point (800c) is present in different rows (a row having the ID=1, a row having the ID=3, and a row having the ID=4) in the column of the identifier (800a), reference is made to the identifier (800a) in the row having a commonality in one row of the column of the identifier link (800d) (e.g., reference is made to the ID=3 and the ID=4 in the row having the ID=1, or reference is made to the ID=3 in the row having the ID=3).

<III> There is provided the information processing method, wherein the unique identifier (800a: e.g., the ID=1 or the ID=3), the encoded feature point (800c: e.g., “4, 242, C25, D . . . 8, 512, T23, E . . . ” or “4, 242, C25, D . . . ”), and/or the identifier (e.g., the ID=3 and the ID=4 referred in the row having the ID=1) which is referred in the identifier link (800d) is used as a data code (corresponding to a mail address) indicative of an address for a user (e.g., “grandpa and grandma” in case of a plurality of persons or “grandpa” in case of a single person) associated with the facial image data (800b).

<IV> There is provided the information processing method, wherein the address management table (800 in FIG. 2) further includes a column of a mail reception folder (800e), a folder name (e.g., a folder name “mail_receive_folder#1” for a folder in the row having the ID=1, and a folder name “mail_receive_folder#2” for a folder in the row having the ID=2) associated with the identifier (800a) in the same row is given to each row in the column of the mail reception folder (800e), mail contents (BLOCK [45] in FIG. 7: e.g., a “video mail from grandchildren to a grandpa and a grandma”) stored in one (e.g., “mail_receive_folder#1”) of the mail reception folders (800e) are transmitted with the identifier (the ID=1) associated with one (“mail_receive_folder#1”) of the mail reception folders being determined as an address (BLOCK [49]), or mail contents (BLOCK [45] in FIG. 7: e.g., the “video mail from grandchildren to a grandpa and a grandma”) stored in one (e.g., “mail_receive_folder#1”) of the mail reception folders (800e) are transmitted with the identifier (the ID=3 and the ID=4) referred by the identifier link (800d) associated with one (“mail_receive_folder#1”) of the mail reception folders being determined as an address (BLOCKs [48] to [49]).

<V> There is provided the information processing method, wherein a facial image (800b in FIG. 2) of the user registered in the address management table (800 in FIG. 2) is displayed to prompt (a user) selection of a specific facial image (BLOCK [42] in FIG. 3), and mail contents, e.g., a video mail created in BLOCK [40] are registered in one (“mail_receive_folder#1” of 800e in FIG. 2) of the mail reception folders associated with the selected facial image, e.g., “grandpa and grandma” (BLOCK [45] in FIG. 7).

<VI> There is provided the information processing method, wherein, when an incoming mail is present, if a user is in front of a camera (BLOCK [11—YES] in FIG. 4), a face of the user is recognized (BLOCK [100]), and a message (ring tone/audio guidance) for the user is reproduced (BLOCK [13]) when the user whose face is recognized corresponds to an address of the mail (when feature point data of the face of the user recognized in BLOCK [100] coincides with feature point data of a face as a mail address in the table depicted in FIG. 2, (BLOCK [12—YES]).

<VII> There is provided an information display apparatus comprising: means (60a, 113) for taking facial image data of a user; means (115) for extracting a feature point of a face of the user from the facial image data and encoding the feature point; and a display (121) which displays a picture and/or an image of a character including an image of the face of the user, wherein the facial image data (“grandpa and grandma”) is supplied to an address management table (800 in the video letter server 80) to be stored in association with a unique identifier (the ID=1) and/or the encoded feature point (800c).

<VIII> There is provided the information display apparatus, further comprising: storage means (the HDD 126 and/or the IC card 127) for storing a copy of contents in the address management table (800 in the video letter server 80).

As explained above, a user can directly select a registered face as an address of a mail by applying the embodiment according to the present invention (the machine does not recognize and select a face, but a user visually confirms and selects a face). Therefore, a mail can be prevented from being transmitted to an incorrect person (a stranger unconnected with the intended mail recipient). Furthermore, an address does not have to be input by operating a keyboard. Further, in an information processing method according to an embodiment of the present invention, facial image data of a user is taken in, and a feature point of a face of the user is extracted from this facial image data to be encoded. Furthermore, a unique identifier and/or the encoded feature point are associated with the facial image data to be registered in an address management table. Moreover, image data of faces are registered in the address management table, and a user can directly select a registered face as an address of a mail (a machine does not recognize a face to be selected, but the user can see a face to be selected). Therefore, a mail can be prevented from being transmitted to a wrong person (a stranger unconnected with a person as a target of transmission). Still over, an address does not have to be input by operating a keyboard.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method comprising:
capturing image data of a face;
extracting a feature point of the face from the image data and encoding the feature point; and
associating at least one of the image data with a unique identifier and the encoded feature point to be registered in an address management table.

2. The method of claim 1, wherein the address management table comprises a column of the identifier, a column of the image data, a column of the feature point, and a column of a link to the identifier and reference is made to the identifier in the row comprising a commonality in one row of the column of the link when the image data comprising a commonality in the feature point is present in different rows in the column of the identifier.

3. The method of claim 2, further comprising:
using at least one of the unique identifier, the encoded feature point, and the identifier referred in the link as a data code indicative of an address for a user comprising the face associated with the image data.

4. The method of claim 3, wherein the address management table further comprises a column of a mail reception folder, the method further comprising:
assigning a folder name associated with the identifier in the same row to each row in the column of the mail reception folder,
transmitting mail contents in one of the mail reception folders with the identifier associated with one of the mail reception folders being determined as an address, or
transmitting mail contents in one of the mail reception folders are with the identifier referred by the link associated with one of the mail reception folders being determined as an address.

5. The method of claim 4, further comprising:
displaying the image associated with the user registered in the address management table;
prompting selection of an image; and
registering mail contents in one of the mail reception folders associated with the selected image.

6. The method of claim 1, further comprising:
recognizing a face associated with a user, when an incoming mail is present and the user is in front of a camera; and
reproducing a message for the user when the face associated with the user is recognized corresponding to an address of the mail.

7. The method of claim 1, wherein the image data is in a predetermined image frame, the image frame comprises a facial image region of the user and a background image region, the method further comprising:
inserting either a solid color or an arbitrary image into the background image region.

8. The method of claim 1 further comprising:
recognizing a face associated with a user, when an incoming mail is present and the user is in front of a camera; and
reproducing a message for the user if the face associated with the user is recognized corresponding to an address of the mail and the user has a wireless key.

9. The method of claim 1 further comprising:
recognizing a face associated with a user, when an incoming mail is present and the user is in front of a camera;
reproducing a message for the user if the face associated with the user is recognized corresponding to an address of the mail; and
using a feature point of the face as a first key of the user and using at least one of an operation of the user and a wireless key of the user as a second key.

10. An information display apparatus comprising:
an image capturer configured to capture image data of a face;
a feature extracting module configured to extract a feature point of the face from the image data and encoding the feature point; and
a display configured to display an image comprising an image the face,
wherein the image data is supplied to an address management table in association with at least one of a unique identifier and the encoded feature point.

11. The apparatus of claim 10, further comprising:
a storage device configured to store a copy of contents in the address management table.
